(19) United States
(12) Patent Application Publication
(10) Pub. No.: US 2016/0091960 A1
(43) Pub. Date: Mar. 31, 2016

(54) CONTROL SYSTEMS FOR REDUCING CURRENT TRANSIENTS

(71) Applicant: Apple, Cupertino, CA (US)

(72) Inventors: James S. ISMAIL, San Jose, CA (US); David A. HARDELL, San Jose, CA (US); Karen S. ECKERT, San Jose, CA (US); Keith COX, Sunnyvale, CA (US)

(21) Appl. No.: 14/500,393

(22) Filed: Sep. 29, 2014

(51) Int. Cl. G06F 1/32

(52) U.S. Cl. CPC G06F 1/3296; G06F 1/324

(57) ABSTRACT

A method, apparatus, and system for reducing current transients of a power supply are disclosed. Specifically, the embodiments discussed herein include a control system configured to throttle a processor of a computing device when the current demanded by the processor from the power supply exceeds a reference current value. Throttling can include reducing or limiting the performance state that the processor can be operable in. Additionally, the control system can be operated according to multiple time domains, allowing the sampling of an input current to be performed at a higher rate than a rate at which analysis on the sampled input current is performed. The processor can remain throttled depending on a delayed release filter, which determines when a processor can return to a performance state that was previously removed.

### FIELD

The present disclosure relates generally to control systems. More specifically, the present embodiments relate to control systems for reducing the current transients occurring between a processor and a power supply.

### BACKGROUND

Modern computing devices have become more advanced over time while also becoming more compact. The limited space within various computing devices has led to a demand for power supplies that are small enough to be easily transported through the daily routine of a typical consumer, while being large enough to manage the sometimes unpredictable power demands of a computing device. In computing devices such as laptops, the laptop can often be designed to be as portable as a cellular phone while having the processing power of a desktop computer. Additionally, the laptop can include a battery for providing the energy needed for performing various tasks while also enabling the laptop to be operable almost anywhere. However, as the processing power of laptops and other portable devices increases, typically the size of the power supply also increases in order to accommodate increasing current demands. Unfortunately, bulkier power supplies can be expensive and inconvenient to carry around, thereby ruining the purpose of designing a computing device for portability.

### SUMMARY

This paper describes various embodiments that relate to control systems for reducing demand currents from a power supply. Specifically, the embodiments relate to throttling a processor using a control system to reduce the current demanded by the processor from a power supply.

In some embodiments, a controller is set forth. The controller can be used to reduce a frequency and/or a peak current value of a transient current induced in an input current supplied, by a power supply, to a computing system having at least one processor. The controller can include an input current filter operable at a first frequency and arranged to sample the input current. The controller can further include a control effort (CE) generator coupled to the input current filter that is operable at a second frequency that is less than the first frequency and uses a sampled input current to provide a CE signal to the at least one processor that reduces the frequency and/or the peak current value of the transient current by throttling at least one processor by reducing a performance (p) state of at least one processor.

In other embodiments, a system is set forth for temporarily reducing a current demand of at least one processor. The system can include a sample generator configured to sample an input current according to a first time domain, and output a current sample from a sample buffer of the sample generator according to a second time domain. The system can further include a process limiter operatively coupled to the sample generator and configured to provide a CE signal according to a signal delay to limit an activity of the at least one processor and delay an increase in the activity of the at least one processor.

In yet other embodiments, a method is set forth for temporarily limiting a power consumption of a processor in response to an increased current demand of the processor from a power supply. The method can include receiving a sampled input current from a sample storage. The sample storage can include an input and output contemporaneously operable at different frequencies, and sample an input current being transmitted between the processor and power supply. The sample storage can further output the sampled input current for comparison to a reference value associated with the power supply. The method can also include a step of limiting the power consumption of the processor when the sampled input current reaches at least the reference value.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings.

FIG. 1 illustrates a perspective view of a computing device powered by a power adapter.

FIG. 2 illustrates a system diagram of a computing device according to some embodiments discussed herein.

FIG. 3 illustrates a system diagram of a power management unit (PMU) according to some embodiments.

FIG. 4 illustrates a diagram of a control decision according to some embodiments.

FIG. 5 illustrates a method for reducing the frequency and peak current value of an input current to a processor.

FIG. 6 illustrates a method for throttling a processor when an input current to the processor exceeds a peak current threshold associated with a power supply.

FIG. 7 illustrates a method for releasing a performance state to a processor according to a time release filter.

FIG. 8 is a block diagram of a computing device that can represent one or more components of the embodiments discussed herein.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The embodiments discussed herein relate to control systems configured to reduce current transients occurring between a system and a power supply. Current transients can be the result of an increase in workload of the system and can cause the power supply to operate out of a specification of which the power supply was designed. Over time, this can eventually cause the power supply to malfunction. The current transients can have a frequency defining how often the current transients spike above or exceed a peak current threshold associated with the specification of the power supply. In order to mitigate potential harm to the power supply, the control system is configured to reduce the frequency and amplitude of these current transients. In this way, although the power supply may occasionally operate out of specification, the amount of time the power supply will be operating out of specification will be reduced. The control system accomplishes this by removing or limiting a workload and/or performance state of the system, thus causing the system to demand less current from the power supply.

The control system can be configured to sample an input current from the power supply. In order to perform the sampling, a sampling filter can be provided in the control system and to be operable in a hybrid domain. In this way, the sampling can occur at a frequency that is higher than a frequency that the samples are output from a buffer of the sampling filter. For example, the sampling can be performed at 10 kilohertz and the outputting of samples from the buffer can be performed at 1 kilohertz. Once in the buffer, the current samples can be filtered according to the operational parameters of the sampling filter. For example, the sampling filter can be configured to not filter the current samples in the buffer as long as the current samples are increasing with respect to time. Alternatively, when the current samples in the buffer are decreasing with respect to time, a single pole filter can be applied to the current samples in order to differentiate between current spikes increasing in peak amplitude, and current spikes decreasing in peak amplitude. In this way, the control system will filter spikes in current that are not indicative of a potentially detrimental transient current. Thereafter, buffered current samples can be output from the buffer according to an output frequency of the sampling filter.

Current samples outputted from the buffer can be provided to an arithmetic operator of the control system. The arithmetic operator can include a comparator configured to compare the current samples to a reference current value associated with the power supply. The reference current value can define a current threshold of the control system. Additionally, the current threshold can correspond to a maximum current specification for the power supply. When a current sample received by the comparator is greater than the reference current value (if a difference between the current sample and the reference current value is a positive number (i.e. an error value)), a control effort signal can be generated by a compensator of the control system, which may be used to throttle the system and reduce a current performance state of the system. The compensator can perform a proportional, integral, and/or derivative operation on an error signal, which is a difference between the reference current value and the current sample, and may come from an output of the arithmetic operator. In this way, the generation of the control effort signal can be based on the result of the operations performed on the error signal. The control effort signal can also be based on a limiter, which can limit a magnitude of the control effort signal, thereby limiting the magnitude of the resulting throttling signal. In this way, because the removal and release of performance states can be based on the magnitude of the throttling signal, the limiter acts limit the range or number of performance states that the system can transition in and out of The limiter can communicate with a memory configured to store a limit or range defining the number of performance states that can be released to or removed from the system. For example, the limiter can receive an output from the compensator and limit the output to a value or range of values in order to ensure that certain performance states are not removed from the system. In some embodiments, the magnitude of the control effort signal can be associated with one or more performance state values of a lookup table stored in the memory. Therefore, the limiter can limit the number of performance state values that the control effort signal can correspond to in the lookup table. The control effort signal can also be provided to the system according to a release filter. The release filter can be configured to slow the decay of the output of the control effort signal in order to prevent frequent throttling of the system. However, in some embodiments, the release filter and limiter can be optional components of the control system.

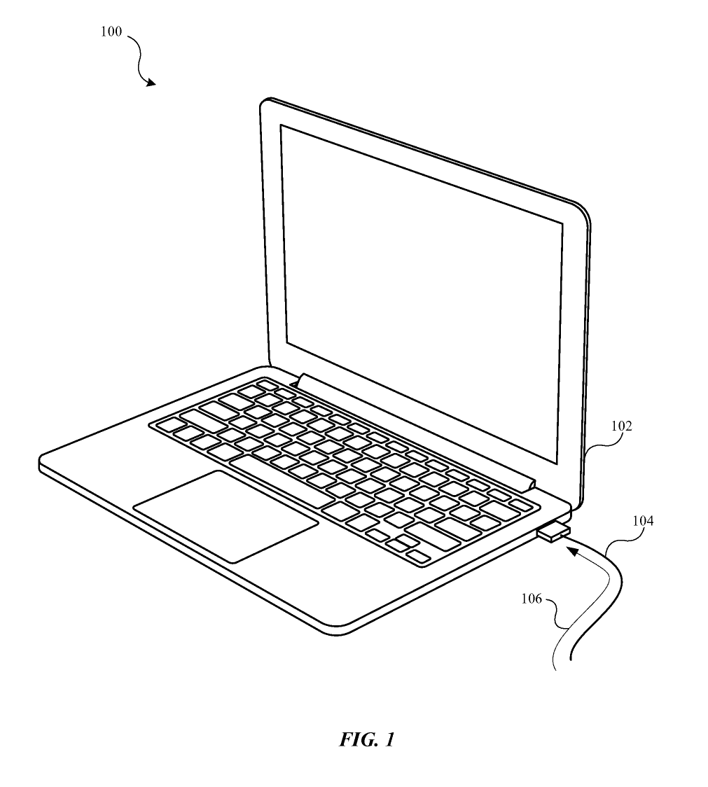

These and other embodiments are discussed below with reference to FIGS. 1-8; however, those skilled in the art will readily appreciate that the detailed description given herein with respect to these figures is for explanatory purposes only and should not be construed as limiting.

FIG. 1 illustrates a perspective view 100 of a laptop computing device 102 powered by a power adapter 104. Specifically, the perspective view 100 sets forth the laptop computing device 102 receiving current 106 in order to both operate the laptop computing device 102 and charge a battery enclosed within the laptop computing device 102. At various times during both charge and operating the laptop computing device 102, the power adapter 104 may be caused to operate out of specification or beyond a current limit that the power adapter 104 was intended. Although many power adapters 104 can often handle operating temporarily out of specification, the longer a power adapter 104 operates above specification, the more likely the power adapter 104 will overheat and potentially become defective or otherwise shutdown. The embodiments discussed herein are set forth to minimize the amount of time that the power adapter 104 operates out of specification in order to safely provide power to the laptop computing device 102, and one or more processors of the laptop computing device 102 without having to design a larger or more powerful power supply for the laptop computing device 102.

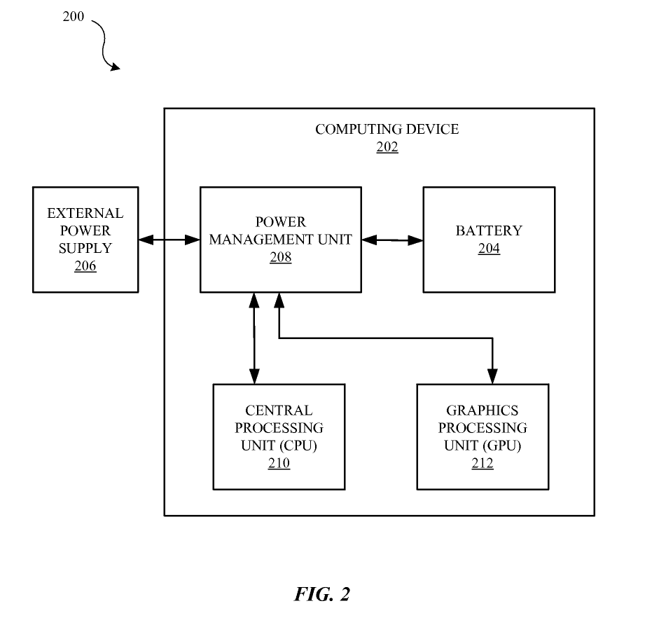

FIG. 2 illustrates a system diagram 200 of a computing device 202 according to some embodiments discussed herein. The computing device 202 can be any type of computer not limited to a cellular phone, laptop, desktop computer, media player, or any suitable computer device having a power supply. The external power supply 206 can be connected and disconnected from the computing device 202 by a user of the computing device 202 in order to allow the transportation of the computing device 202. The computing device 202 can include a battery 204 that can be charged by the external power supply 206 in order to provide power to the computing device 102 when then computing device 202 is being transported. In order to manage power being provided to the various internal components of the computing device 202, a power management unit (PMU) 208 can be included in the computing device 202. The PMU 208 is responsible for monitoring, regulating, distributing, and otherwise controlling power throughout the computing device 202. The PMU 208 can include a central processing unit (CPU) and memory containing software and/or firmware for enabling the various operations of the PMU 208. In some embodiments, the PMU 208 can include a microcontroller for assisting the PMU 208 in controlling power throughout the computing device 202, as further discussed herein. The computing device 202 can further include one or more CPU's 210 and/or one or more graphics processing units (GPU) 212. The CPU 210 and GPU 212 can be configured to execute the various functions of the computing device 202 using power provided from the battery 204 and/or the external power supply 206 according to the PMU 208.

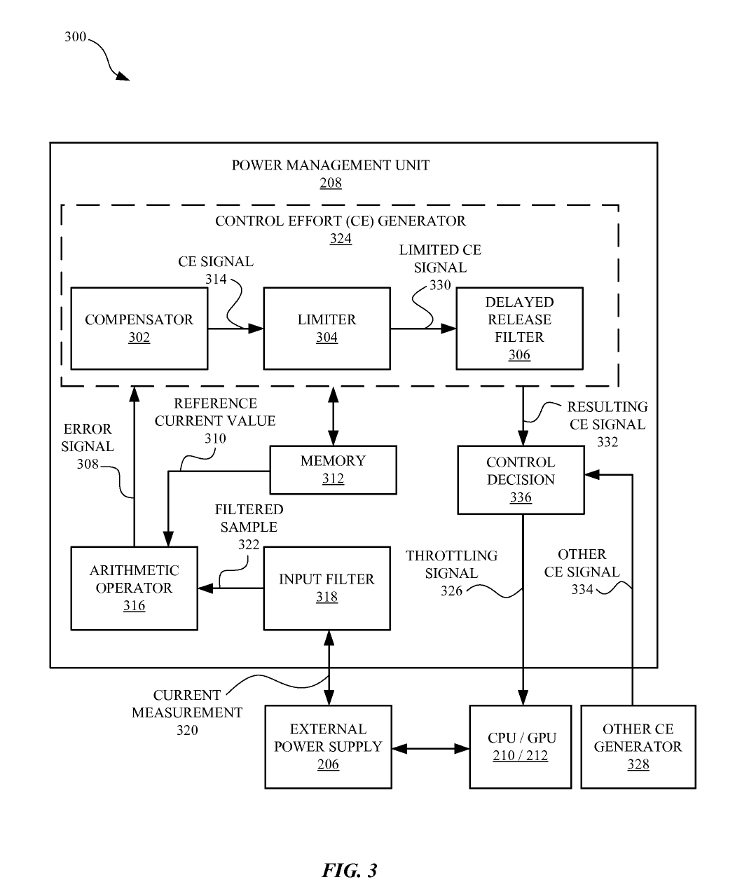

FIG. 3 illustrates a system diagram 300 of the PMU 208 according to some embodiments. Specifically, FIG. 3 illustrates some of the control functions that can be included in the PMU 208 in order to limit the occurrence of current transients from the external power supply 206 created during the operation of the computing device 202. The PMU 208 can be configured to derive a measurement of the amount of current being drawn from the external power supply 206 by the computing device 202. Furthermore, the external power supply 206 can be electrically coupled to an input filter 318 to provide the measurement to the input filter 318. The input filter 318 can operate as a hybrid domain filter for sampling and buffering current samples from the external power supply 206 according to different time domains. For example, in some embodiments, a current measurement 320 is sampled by the input filter 318 at a faster rate than an output rate of a buffer of the input filter 318. In this way, the input filter 318 will buffer multiple current samples and output one filtered sample 322 according to the output rate. Additionally, in some embodiments the input filter 318 is a one-sided filter that does not filter a buffered current sample when the buffered current sample is greater than one or more previous buffered current samples. However, when the buffered current sample is not greater than one or more previous current samples, the input filter 318 can be configured to filter the buffered current sample. Therefore, when a trend in the magnitude of the buffered current samples is decreasing, the buffered current samples will be filtered by the input filter 318. In this way, the input filter 318 can filter buffered current samples when relatively low amplitude spikes in current samples are occurring and not filter buffered current samples when relatively high amplitude spikes in current are occurring. A type of filter that can accomplish this, for example, is a one-sided unity-gain, single pole, relative-degree-one filter. Such a filter acts to filter a lower range of frequencies of the buffered current samples according to a single frequency boundary defined by the single pole and apply an equal gain in the frequency domain, only when the input is increasing.

After the filtered sample 322 is output from the input filter 318, an arithmetic operator 316 can be configured to receive the filtered sample 322. The arithmetic operator 316 can comprise a comparator configured to compare the filtered sample 322 to a reference current value 310. The reference current value 310 can be a value stored in a memory 312 of the PMU 208 or of the computing device 202 that the PMU 208 is operable within. In some embodiments, the reference current value 310 is generated as a result of the power supply 206 initially being plugged into the computing device 202. In response, the PMU 208 or other system of the computing device 202 can determine the type of power supply 206 that is plugged in and generate the reference current value 310 according to the type of power supply 206. In other embodiments, the power supply 206 can provide a reference signal to the PMU 208 or computing device 202 that identifies the power supply 206 and/or indicates the appropriate reference current value 310 to be provided for comparing to the buffered current samples. The reference current value 310 can be updatable by the PMU 208, computing device 202, and/or the external power supply 206. For example, the reference current value 310 can correspond to a peak current threshold for a particular external power supply 206. The PMU 208 can store one or more reference current values 310 that correspond to one or more external power supplies 206 that can be coupled to the computing device 202. The PMU 208 can supply one or more reference current values 310 to the arithmetic operator 316, which can be configured to generate an error signal 308 based on a difference or comparison between the reference current value 310 and a buffered current sample. Additionally, the reference current value 310 can be updated through a software and/or a firmware update of the computing device 202 or PMU 208. In this way, as new power adapters are designed, the PMU 208 can be configured to operate with the new power adapters. Additionally, in some embodiments, when a power adapter is attached to the computing device 202, the reference current value 310 can be provided by the power adapter to the PMU 208. Such an embodiment allows the PMU 208 to receive different reference current values 310 from different power adapters.

The arithmetic operator 316 can be configured to perform a logical operation according to a comparator included in the arithmetic operator 316. The logical operation can involve determining whether the reference current value 310 is greater than, equal to, or less than the filtered sample 322. The result of the logical operation can be included in the output error signal 308. The arithmetic operator 316 can also be configured to perform a mathematical operation on the filtered sample 322 and the reference current value 310. For example, in some embodiments, the filtered sample 322 can be subtracted from the reference current value 310 and the difference can be included in the error signal 308. Additionally, the filtered sample 322 and the reference current value 310 can be added, multiplied, divided, or otherwise combined through an arithmetic operation in order to gauge how close to or above a peak current threshold the external power supply 206 is operating. In some embodiments, the error signal 308 is only output when the filtered sample 322 is equal to or greater than the reference current value 310. In other embodiments, the error signal 308 is also output when the filtered sample 322 is less than the reference current value 310, however, in such an instance the error signal 308 may not cause a throttling of the CPU 210 and/or GPU 212.

The PMU 208 can include a control effort (CE) generator 324 having a compensator 302, and optionally a limiter 304 and delayed release filter 306. The control effort generator 324 may receive one or more input signals (e.g., the error signal 308 from the arithmetic operator 316), and may output a control effort signal, which may be used to throttle the system. The compensator 302 for conditioning one or more input signals being input into the compensator 302. For example, in some embodiments, the compensator 302 is an integral compensator that can integrate one or more input signals (e.g., error signals 308) provided to the compensator 302. Furthermore, the compensator 302 can be a proportional, integral, and/or derivative compensator 302, or any combination thereof. For example, the compensator 302 can be configured to multiply one or more error signals 308 by a gain value and integrate the resulting multiplied one or more error signals when the compensator 302 is configured as a proportional integral controller. Thereafter, the CE generator 324 can output the CE signal 314 based on the output of the compensator 302, which may be used to throttle the system (e.g., CPU 210 and/or GPU 212) based on a result of the computations performed by the compensator 302.

A limiter 304 can optionally be provided in the CE generator 324 for limiting the performance states that can be removed from and/or released to the CPU 210 and/or GPU 212. The operation of the limiter 304 can be based on an output of the compensator 302 and data provided in the memory 312. For example, the limiter 304 can be configured to access certain parameters in memory 312 and generate a limited CE signal 330. The limited CE signal 330 corresponds to a CE signal 314 with a magnitude that has been limited by the limiter 304. In this way, the limiter can limit which performance states can and/or cannot be removed from the CPU 210 and/or GPU 212, as further discussed herein. For example, the limiter 304 can prevent the CE signal 314 from causing all the performance states from being removed from the CPU 210 and/or GPU 212. Additionally, in some embodiments the limiter 304 can be associated with parameters including a lower limit and/or an upper limit of performance states that can or cannot be removed. Furthermore, in other embodiments, a range of performance states can be associated with the limiter 304 in order to prevent the CE signal 314 from causing performance states outside or inside of the range from being removed. The limiter 304 can also be configured to access a lookup table in memory 312 and identify a first performance state that the CE signal 314 is associated with. Thereafter, the limiter 304 can modify the CE signal 314 to be associated with a second performance state if the limiter 304 determines that the first performance state was outside of a range of performance states that can be removed from the CPU 210 and/or GPU 212.

The CE generator 324 can also optionally include a delayed release filter 306. The delayed release filter 306 can be configured to slow or otherwise limit a rate of decrease of the CE signal 314 generated by the CE generator 324, which in turn may delay the removal and/or release of performance states at the CPU 210 and/or GPU 212. During the operation of the PMU 208, a performance state may be removed and returned to the CPU 210 and/or GPU 212 multiple times. However, because frequent throttling between performance states can interfere with the performance of the CPU 210 and/or GPU 212, it can be beneficial to delay the release of performance states back to the CPU 210 and/or GPU 212 in order for the current demanded from the external power supply 206 by the CPU 210 and/or GPU 212 to remain low for a period of time. The period of delay can depend on a stored time delay constant of the delayed release filter 306. The time delay constant can be set during manufacturing of the PMU 208 or anytime thereafter by any suitable software modification such as a software update provided by the manufacturer. The delayed release filter 306 can be configured to act as a single pole filter that does not filter the CE signal 314 when the CE signal is increasing but filters the CE signal 314 when the CE signal 314 is decreasing. When the CE signal 314 is decreasing, the delayed release filter 306 can regulate the decay or decrease of the CE signal 314 in order to slow down the decay of the CE signal 314. In this way, the CE signal 314 will release one or more performance states at a later point than a decreasing CE signal 314 that is unfiltered.

The CE generator 324 can communicate with a control decision 336. The control decision 336 can be configured to receive an input that includes a resulting CE signal 332. The resulting CE signal 332 can correspond to the CE signal 314, a limited signal in instances where the CE generator 324 includes the limiter 304, and/or a delayed-release signal in instances where the CE generator 324 includes the delayed release filter 306. The control decision 336 can also be configured to output a throttling signal 326. The throttling signal 326 can in turn set a maximum performance state for one or more components of the electronic device (e.g., one or more processors such as CPU 210 and/or GPU 212. Lowering the maximum performance state (i.e., removing a performance state) of a processor may reduce or otherwise constrain the power consumed due to operation of the processor, while raising the maximum performance state (i.e., releasing a performance state) may allow the processor to operate in a manner that may consume more power. The performance states to be released or removed are based on a performance limit corresponding to an input to the control decision 336. For example, as the value of the CE signal 314 increases, the resulting throttle signal may remove additional performance states. In some instances, the number of performance states that can be removed from a component may be limited (e.g., to provide for a minimum operating level for that component). Conversely, as the value of the CE signal 314 decreases, performance states may be released back to the components such as CPU 210 and/or GPU 212. The number of performances states that may be released to a component may be limited. In some embodiments, the performance limit corresponding to a certain input value can be different depending on whether the CE signal 314 is increasing or decreasing. For example, when the CE signal 314 is increasing, a performance limit can be associated with a first CE value, and when the CE signal 314 is decreasing, the same performance limit can be associated with a second CE value that is less than the first CE value. In this way, the performance states removed when the input was above the first CE value will not be released until the input falls below both the first CE value and the second CE value. The control decision 336 can include one or more tables (e.g., a hysteresis table or lookup table) in order to perform the functions associated with the control decision 336 discussed herein.

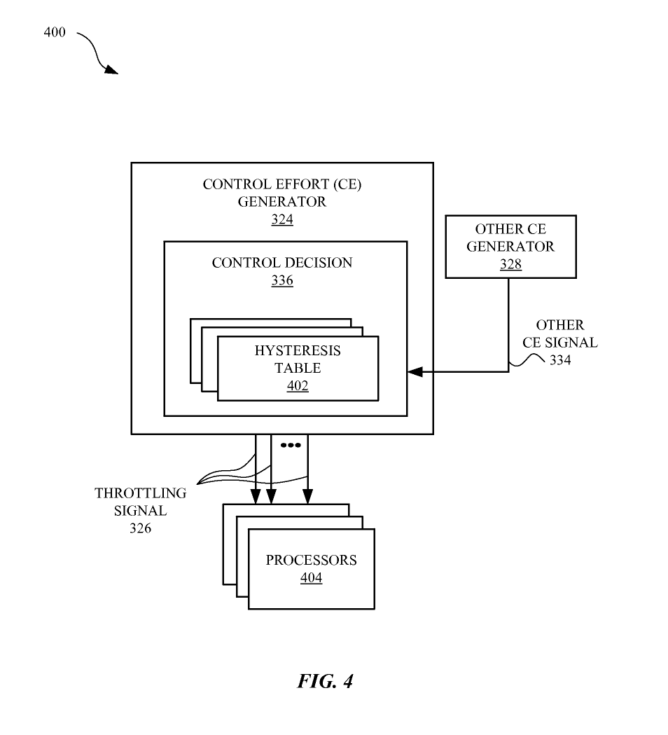

FIG. 4 illustrates a diagram 400 of the control decision 336 according to some embodiments. Specifically, in some embodiments the control decision 336 can include one or more hysteresis tables 402 each configured to perform one or more functions of the control decision 336 based on an input (shown in FIG. 3), as discussed herein. The input of the control decision 336 can include the CE signal 314 (which may be a limited signal in instances where the CE generator 324 includes the limiter 304, and/or a delayed-release signal in instances where the CE generator 324 includes the delayed release filter 306). Each of the one or more hysteresis tables 402 can receive one or more of the inputs and determine based on the inputs whether to remove or release a performance state at the processors 404 (such as the CPU 210 and/or GPU 212 discussed herein). Additionally, the control decision 336 can also receive other CE signals 334 from one or more other CE generators such as the other CE generator 328 illustrated in FIG. 4. In this way, the control decision 336 can selectively react to various control effort inputs having one or more ranges of values. The control decision 336 can determine a controlling CE signal, such as the other CE signal 334 or resulting CE signal 332, that requires the greatest power throttling at a given moment. Thereafter, the control decision 336 can output a throttling signal based on the controlling CE signal. For example, the other CE generator 328 can generate the other CE signal 334 that necessitates throttling of the one or more processors 404 more immediately than the resulting CE signal 332. In response, the control decision 336 can generate a throttling signal based on the other CE generator 328, even if the resulting CE signal 332 of the CE generator 324 does not necessitate such action by the control decision 336. Moreover, one or more of the processors 404 can be throttled based on the resulting CE signal 332 when the input from the other CE generator 328 does indicate a need for throttling, but the resulting CE signal 332 indicates a more immediate need for throttling.

In some embodiments, the control decision 336 is configured to order the throttling of certain processors 404 in a certain way. For example, in some embodiments control decision 336 is configured to cause the CPU 210 to be throttled before the GPU 212 is throttled. Furthermore, in some embodiments, the GPU 212 can be throttled before the CPU 210, or both the GPU 212 and the CPU 210 can be throttled contemporaneously. The throttling can be based on performance states specifically associated with either the CPU 210 or the GPU 212, or both. Therefore, one or more hysteresis tables 402 can be associated with performance states exclusively operable by the CPU 210 or the GPU 212. The control decision 336 can further be configured to provide an order for the release of performance states after one or more performance states have been removed or reduced. Moreover, the control decision 336 can be updateable by the system or manufacturer in order to adapt to new power supplies that can be designed to supply power to the various processors 404 communicatively coupled to the CE generator 324.

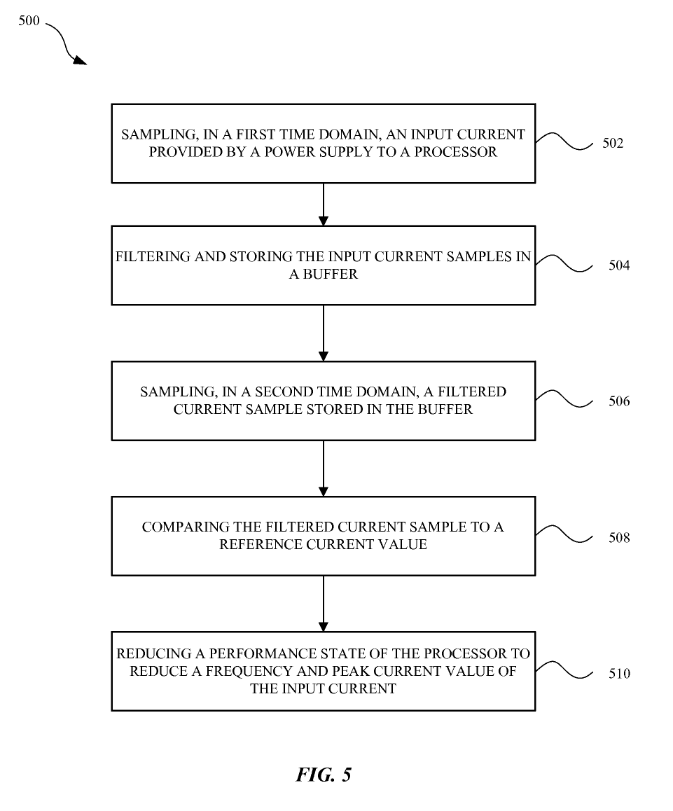

FIG. 5 illustrates a method 500 for reducing the frequency and peak current value of a transient current associated with a power supply. The method 500 can be performed by an input filter or any other suitable apparatus or software module. The method 500 can include a step 502 of sampling, in a first time domain, an input current provided by a power supply to a processor. The method 500 can further include a step of filtering and storing input current samples in a buffer. The buffer can be provided in the input filter or any other suitable memory communicatively coupled to the input filter. At step 506, the method 500 includes sampling, in a second time domain, a filtered current sample from the buffer. The first time domain and second time domain can refer to a first frequency corresponding to the first time domain that is greater than, equal to, or less than a second frequency corresponding to the second time domain. The method can further include a step 508 of comparing the filtered current sample to a reference current value. The reference current value can be associated with the power supply, allowing varying reference values to be used in method 500 depending on the power supply. Additionally, the method 500 can include a step 510 of reducing a performance state of the processor to reduce a frequency and peak current value of current transients occurring as a result of the operation of the power supply. The frequency can refer to the number of times the current transients, resulting from increased input current, stay above the reference current value for a period of time, and the peak current value can refer to the maximum amount of current demanded by the processor from the power supply.

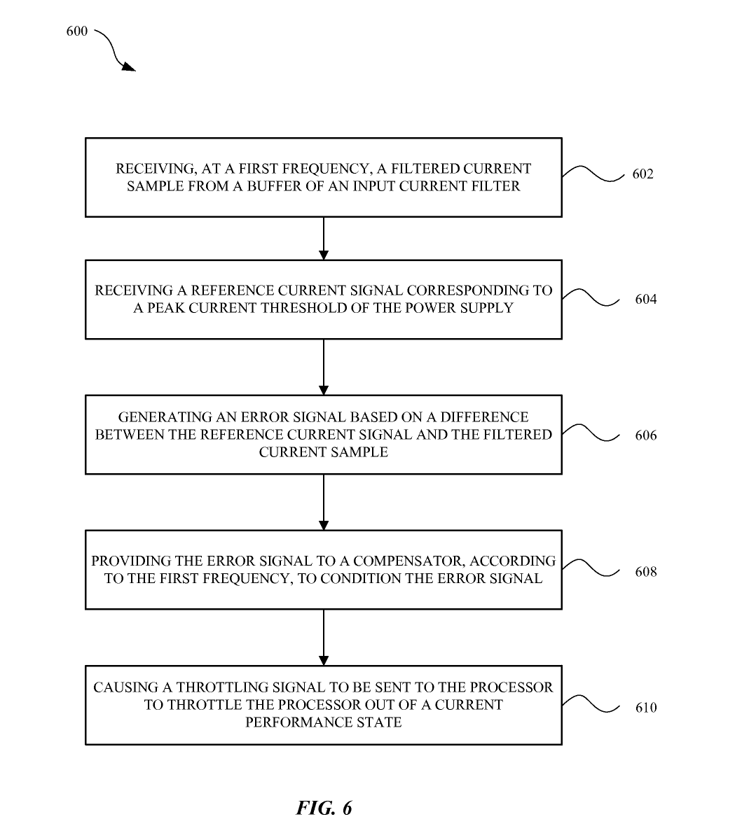

FIG. 6 illustrates a method 600 for throttling a processor when an input current to the processor exceeds a peak current threshold associated with a power supply. The method 600 can be performed by a comparator or any other suitable apparatus or software module. The method 600 can include a step 602 of receiving, at a first frequency, a filtered current sample from a buffer of an input current filter. At step 604, the method 600 includes receiving a reference current signal corresponding to a peak current threshold of the power supply. The method 600 further includes a step 606 of generating an error signal based on a difference between the reference current signal and the filtered current sample from the buffer. Additionally, the method 600 includes a step 608 of providing the error signal to a compensator to condition the error signal. To condition the error signal, the error signal can be integrated with one or more previous error signals. Additionally, a derivative of the error signal with respect to the previous one or more error signals can be derived to condition the error signal. The error signal can also be multiplied by a constant for conditioning the error signal. The result of these operations, alone or in combination, can be useful when determining whether to throttle the processor because the resulting values can be more manageable as they may be scaled to larger values and can reveal trends in the error signal over time.

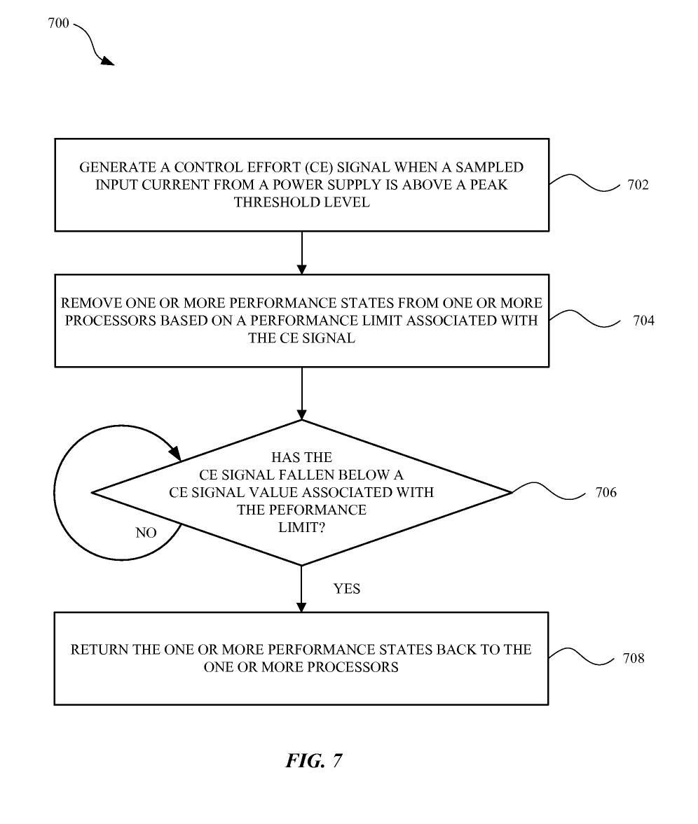

FIG. 7 illustrates a method 700 for releasing a performance state to a processor according to an imposed limit. The method 700 can be performed by any suitable apparatus or software module such discussed herein such as the limiter or the control effort generator. The method 700 can include a step 702 of generating a control effort (CE) signal when a sampled input current from a power supply is above a peak threshold level. The method 700 can further include a step 704 of removing or reducing one or more performance states from one or more processors based on a performance limit associated with the CE signal. The performance limit can represent a limit on which performance states the CE signal can remove from or release to the one or more processors, as discussed herein. For example, in some embodiments a hysteresis table can map the order that performance states are removed from the processor thereby allowing multiple performance states to be unavailable to the processor at a given time. Performance states can include turbo states which, according to the hysteresis table, can be removed before or after a non-turbo state of a CPU and/or a GPU have been removed. Performance states can refer to different arrangements of operation for a processor and can define a frequency and/or voltage at which the processor will operate. Because a performance state having a high frequency and high voltage will consume more power and therefore directly relate to the current demand of the processor, it is preferable to reduce or remove such a performance state of the processor when the power supply is operating above a peak current threshold. It should be noted that any other suitable operations for throttling a processor or reducing the power consumption of a processor can be executed based on the throttling signal or CE signal discussed herein. For example, the throttling signal 326 from the PMU 208 can cause a reordering or sharing of operations at one or more processors in order to reduce the power consumption of the one or more processors. Moreover, clock speed can be adjusted according to the CE signal 314 in order to reduce the amount of current demanded by the processor.

The method 700 of FIG. 7 can further include a step 706 where a determination is made as to whether the CE signal has fallen below or equal to a CE signal value associated with the performance limit. If the CE signal has not fallen below or equal to the CE signal value, step 706 is repeated. However, if the CE signal has fallen below or equal to the CE signal value, the method 700 proceeds to step 708 of returning one or more performance states back to the one or more processors. In this way, returning the performance states back to the processor allows the processor to operate according to the one or more performance states that were previously removed in step 704.

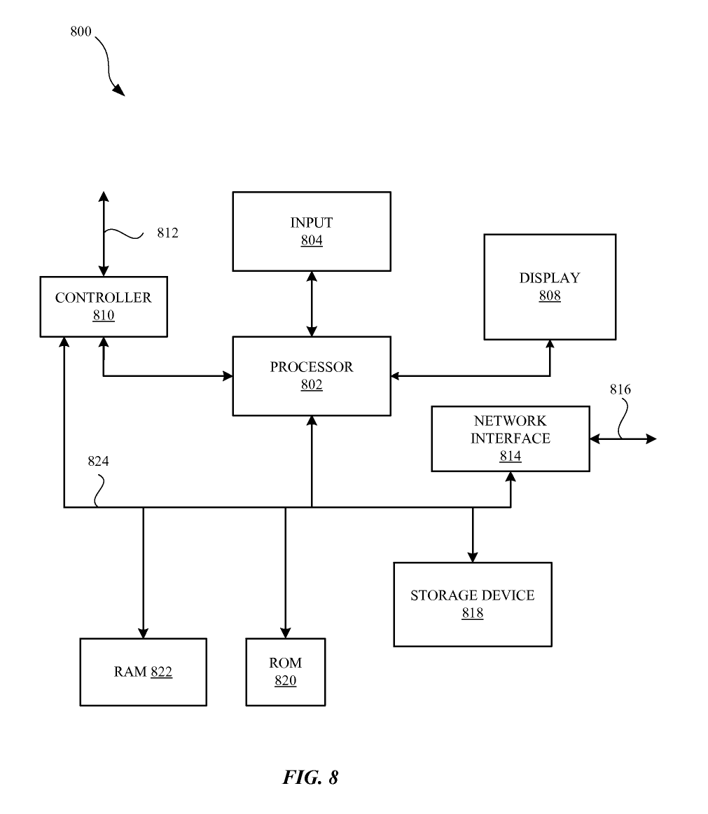

FIG. 8 is a block diagram of a computing device 800 that can represent the components of the PMU 208 and/or the computing device 202. It will be appreciated that the components, devices or elements illustrated in and described with respect to FIG. 8 may not be necessary and thus some may be omitted in certain embodiments. The computing device 800 can include a processor 802 that represents a microprocessor, a coprocessor, circuitry and/or a controller for controlling the overall operation of computing device 800. Although illustrated as a single processor, it can be appreciated that the processor 802 can include a plurality of processors. The plurality of processors can be in operative communication with each other and can be collectively configured to perform one or more functionalities of the computing device 800 as described herein. In some embodiments, the processor 802 can be configured to execute instructions that can be stored at the computing device 800 and/or that can be otherwise accessible to the processor 802. As such, whether configured by hardware or by a combination of hardware and software, the processor 802 can be capable of performing operations and actions in accordance with embodiments described herein.

The computing device 800 can also include user input device 804 that allows a user of the computing device 800 to interact with the computing device 800. For example, user input device 804 can take a variety of forms, such as a button, keypad, dial, touch screen, audio input interface, visual/image capture input interface, input in the form of sensor data, etc. Still further, the computing device 800 can include a display 808 (screen display) that can be controlled by processor 802 to display information to a user. Controller 810 can be used to interface with and control different equipment through equipment control bus 812. The computing device 800 can also include a network/bus interface 814 that couples to data link 816. Data link 816 can allow the computing device 800 to couple to a host computer or to accessory devices. The data link 816 can be provided over a wired connection or a wireless connection. In the case of a wireless connection, network/bus interface 814 can include a wireless transceiver.

The computing device 800 can also include a storage device 818, which can have a single disk or a plurality of disks (e.g., hard drives) and a storage management module that manages one or more partitions (also referred to herein as “logical volumes”) within the storage device 818. In some embodiments, the storage device 818 can include flash memory, semiconductor (solid state) memory or the like. Still further, the computing device 800 can include Read-Only Memory (ROM) 820 and Random Access Memory (RAM) 822. The ROM 820 can store programs, code, instructions, utilities or processes to be executed in a non-volatile manner. The RAM 822 can provide volatile data storage, and store instructions related to components of the storage management module that are configured to carry out the various techniques described herein. The computing device 800 can further include data bus 824. Data bus 824 can facilitate data and signal transfer between at least processor 802, controller 810, network interface 814, storage device 818, ROM 820, and RAM 822.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable storage medium. The computer readable storage medium can be any data storage device that can store data which can thereafter be read by a computer system. Examples of the computer readable storage medium include read-only memory, random-access memory, CD-ROMs, HDDs, DVDs, magnetic tape, and optical data storage devices. The computer readable storage medium can also be distributed over network-coupled computer systems so that the computer readable code is stored and executed in a distributed fashion. In some embodiments, the computer readable storage medium can be non-transitory.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A controller used to reduce a frequency and/or a peak current value of a transient current induced by an input current supplied, by a power supply, to a computing system having at least one processor, the controller comprising:
an input current filter operable at a first frequency and arranged to sample the input current; and
a control effort generator coupled to the input current filter, the control effort operable at a second frequency that is less than the first frequency and configured to use a sampled input current to provide a control effort signal to the at least one processor to reduce the frequency and/or the peak current value of the transient current by throttling the at least one processor thereby reducing a performance state of the at least one processor.

2. The controller of claim 1, wherein the first frequency and the second frequency are tunable for reducing the frequency and/or the peak current value.

3. The controller of claim 1, wherein the control effort generator comprises:
a limiter configured to limit a magnitude of the control effort signal.

4. The controller of claim 1, wherein the control effort generator comprises:
a release filter configured to slow a decay of the control effort signal.

5. The controller of claim 1, wherein the control effort signal is based on a difference between the sampled input current and a reference signal corresponding to a peak current threshold of the power supply.

6. The controller of claim 5, wherein the control effort generator is configured to provide the reference signal corresponding to a power specification for a particular power supply.

7. The controller of claim 5, wherein the reference signal is encoded as updatable firmware in the power supply.

8. The controller of claim 1, wherein the input current filter is a one-sided filter that filters the input current when the input current decreases with respect to a previous current sample.

9. The controller of claim 8, wherein the input current is unfiltered by the input current filter when the input current increases with respect to the previous current sample.

10. The controller of claim 1, wherein the at least one processor includes a central processing unit (CPU) and a graphics processing unit (GPU), and the computing system includes a memory storing a hysteresis table configured to provide an order for throttling the CPU and the GPU.

11. The controller of claim 10, wherein the hysteresis table is further configured to cause a CPU performance state to be removed before removing a GPU performance state.

12. A system for temporarily reducing a current demand of at least one processor, the system comprising:
a sample generator configured to:
sample an input current according to a first time domain, and
output a current sample from a sample buffer of the sample generator according to a second time domain; and
a process limiter operatively coupled to the sample generator and configured to provide a control effort signal according to a signal delay to limit an activity of the at least one processor and delay an increase in the activity of the at least one processor.

13. The system of claim 12, wherein the control effort signal is provided when an error signal reaches an error threshold, wherein the error signal is calculated based on the current sample and a reference current value.

14. The system of claim 13, further comprising:
a compensator configured to integrate one or more error values to generate the error signal, wherein the errors values are based on a difference between the current sample and the reference current value.

15. The system of claim 12, wherein the sample generator is further configured to filter the input current when the input current decreases relative to a previous sampled input current.

16. A method for temporarily limiting a power consumption of a processor in response to an increased current demand of the processor from a power supply, the method comprising:
receiving a sampled input current from a sample storage configured to:
include an input and output contemporaneously operable at different frequencies,
sample an input current, between the processor and power supply, and
output the sampled input current for comparison to a reference value associated with the power supply; and
limiting the power consumption of the processor when the sampled input current reaches at least the reference value.

17. The method of claim 16, wherein limiting the power consumption of the processor includes temporarily reducing a performance state of the processor according to a performance limit and based on the sampled input current.

18. The method of claim 17, further comprising:
returning a previous performance state to the processor after a subsequent sampled input current is determined to be less than the reference value.

19. The method of claim 16, wherein receiving the sampled input current from the sample storage includes receiving a most recent sampled input current from a plurality of input current samples.

20. The method of claim 16, further comprising:
comparing the sampled input current to the reference value to generate an error signal, and
evaluating a trend of multiple error signals over multiple iterations of the comparing.
